(19) United States
(12) Patent Application Publication
(10) Pub. No.: US 2023/0394347 A1
(43) Pub. Date: Dec. 7, 2023

(54) CONTROLLED JITTER INJECTION INTO A SIGNAL

(71) Applicant: INTERNATIONAL BUSINESS MACHINES CORPORATION, Armonk, NY (US)

(72) Inventors: Jarrett Betke, Hoffman Estates, IL (US); Timothy Lindquist, Rochester, MN (US); George Paulik, Rochester, MN (US); Karl Erickson, Rochester, MN (US); Daniel Ramirez, Rochester, MN (US); George Russell Zettles, IV, Rochester, MN (US)

(21) Appl. No.: 17/834,852

(22) Filed: Jun. 7, 2022

(51) Int. Cl. G06N 10/40

(52) U.S. Cl. CPC G06N 10/40

(57) ABSTRACT

A method of controlling a quantum computing output includes generating a baseline quantum computing signal from a quantum computing system. A controlled noise component is added to the quantum computing system. An output from the quantum computing system is read, wherein the output includes the controlled noise component. An effect on the baseline quantum computing signal due to the controlled noise component in the output is determined.

### BACKGROUND

### Technical Field

The present disclosure generally relates to quantum processing, and more particularly, to a controlled jitter injection into a signal.

### Description of the Related Art

Quantum computer processing generally involves signal measurements taken in highly sensitive conditions. For example, some quantum computers use a physical type of qubit called a superconducting transmon qubit. For a superconducting qubit to behave as the abstract notion of the qubit, the device is operated at extremely low temperatures (e.g., 15 millikelvin in a dilution refrigerator) to minimize ambient noise or heat that could excite the superconducting qubit and increase the rate at which its state decoheres. In traditional or conventional signal processing applications, noise is considered a parasitic element that is undesirable.

In quantum computing, quantum randomness is not simply like a classical random coin flip. An isolated quantum system will be in a definite state, but the outcome of a measurement of that system will be random, with the probabilities of the possible outcomes determined by parameters defining the state. Noise in a system can alter these probabilities and thus the statistics of the measurement outcomes, which in turn can compromise a computation.

One of the challenges a designer faces is determining the maximum noise a system could experience under normal operation and its effects on the system. Models and simulation often make assumptions to simplify calculations. Without the simplification by way of assumption, the simulation may be unsolvable in a useful period. The result is that systems are often overdesigned, adding design margin upon design margin derived from simulations with assumptions which are too conservative. In a laboratory, there are not many adequate ways to test margins without very complex equipment that requires engineered methods to introduce noise signals into the system hardware.

### SUMMARY

According to an embodiment of the present disclosure, a method of controlling a quantum computing output is provided. The method generates a baseline quantum computing signal from a quantum computing system. A controlled noise component is added to the quantum computing system. An output from the quantum computing system is read. The output includes the controlled noise component. An effect on the baseline quantum computing signal due to the controlled noise component in the output is determined.

In one embodiment, the controlled noise component is jitter. As may be appreciated, adding jitter to a signal allows engineers a controlled manner to test out margins in a quantum computing system. Jitter may be easily generated and the threshold of noise in the system may be readily identified. As such, margins do not need to be simulated with extra margin for error. Injecting jitter thus provides a controlled signal that shows qubit behavior where the threshold noise can be accounted for.

According to an embodiment of the present disclosure, a computer program product for controlling a quantum computing output is provided. The computer program product includes one or more computer readable storage media, and program instructions collectively stored on the one or more computer readable storage media. The program instructions include generating a baseline quantum computing signal from a quantum computing system. A controlled noise component is added to the quantum computing system. An output from the quantum computing system is read. The output includes the controlled noise component. An effect on the baseline quantum computing signal due to the controlled noise component in the output is determined.

In one embodiment, the controlled noise component is amplitude noise. As may be appreciated, adding amplitude noise to a signal is another technique that allows engineers a controlled manner to test out margins in a quantum computing system. Amplitude noise may be easily generated by, for example, using off the shelf supplies or adding additional information into the data going to a digital to analog converter.

According to an embodiment of the present disclosure, a controller module for controlling a quantum computing output in a quantum computing system is provided. The controller module includes a computer processor, a controlled noise source generator, and one or more computer readable storage media. There are program instructions collectively stored on the one or more computer readable storage media. The program instructions include, when executed by the computer processor: generating a baseline quantum computing signal from a quantum computing system; adding a controlled noise component, generated by the controlled noise source generator, to the quantum computing system; reading an output from the quantum computing system, wherein the output includes the controlled noise component; and determining an effect on the baseline quantum computing signal due to the controlled noise component in the output.

In one embodiment, the controlled noise component is produced from a number generator. In the context of the subject technology, a number generator may behave similar to a state machine. The number generator may operate independently from the numerically controlled oscillator, which allows users to track the values being injected into the system. For example, the number generator may generate numbers dependent/independently from the numerically controlled oscillator. As such, the amount of jitter (or other noise) produced can be calculated by the same off set values the number generator is producing for a look up table method.

According to an embodiment of the present disclosure, a quantum computing system is provided. The quantum computing system includes a computing device that includes a computer processor, a digital signal generator coupled to the computing device, and a controlled noise source module coupled to the digital signal generator. The computer processor is configured to generate a baseline quantum computing signal from the digital signal generator. A controlled noise signal is generated from the controlled noise source module. The controlled noise signal is injected into the baseline quantum computing signal. A modified quantum computing signal is generated showing an effect on a qubit behavior due to the controlled noise signal.

In one embodiment, the controlled noise signal is an offset value added to a value obtained from a look up table. By using an offset value, the threshold margins are easily tracked and controlled. Thus, the behavior of qubits in a system are more accurately observed as the effects of noise in the system are controlled.

The techniques described herein may be implemented in a number of ways. Example implementations are provided below with reference to the following figures.

### BRIEF DESCRIPTION OF THE DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 is a block diagram of a numerically controlled oscillator, consistent with an illustrative embodiment.

FIG. 2 is a diagrammatic view of a look up table process, consistent with an illustrative embodiment.

FIG. 3 is a flow chart of a process for injecting controlled noise into a quantum computing system, consistent with an illustrative embodiment.

FIG. 4 is a diagrammatic view of a process of injecting controlled noise into a quantum computing system, consistent with an illustrative embodiment.

FIG. 5 is a diagrammatic view of a look up table showing examples of offset values identified for use in a signal, consistent with an illustrative embodiment.

FIG. 6A is a plot of a bi-modal distribution, consistent with an illustrative embodiment.

FIG. 6B is a plot of a Gaussian distribution, consistent with an illustrative embodiment.

FIG, 7 is a diagrammatic view of an interrupt service routine for simulating output amplitude instability, consistent with an illustrative embodiment.

FIG. 8 is a series of plots showing effects of injected phase noise into a quantum system, consistent with an illustrative embodiment.

FIG. 9 is a series of plots showing effects of injected amplitude noise into a quantum system, consistent with an illustrative embodiment.

FIG. 10 is a block diagram of a computing hardware platform, consistent with an illustrative embodiment.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well-known methods, procedures, components, and/or circuitry have been described at a relatively high-level, without detail, in order to avoid unnecessarily obscuring aspects of the present teachings.

The present disclosure generally relates to quantum computing processing and a signal generating technique that introduces controlled noise source into the output of a quantum computing system.

### Definitions:

Jitter: a deviation from true periodicity of a presumably periodic signal, in relation to a reference clock signal.

Amplitude Noise: a noise signal that occurs when the amplitude of the signal output by an amplifier or other device is not a linear function of the input amplitude.

Numerically Controlled Oscillator (NCO): a digital signal generator that creates a synchronous, discrete-time, discrete-valued representation of a waveform.

Digital to Analog Converter (DAC): a system that converts a digital signal into an analog signal.

Quantum Computing System: a system for computation that harnesses the collective properties of quantum states, such as superposition, interference, and entanglement, to perform calculations based on a qubit.

### Overview

Referring to the Figures in general, embodiments disclose a numerically controlled oscillator (NCO) that injects controlled noise into a quantum computing system. In one aspect, the embodiments may characterize qubit sensitivity to noise sources. Embodiments may include automated characterization (for example, where a computing processor analyzes an output signal for the effects of noise). While other embodiments may allow for technicians to compare baseline signals to artificially noise induced signals to evaluate qubit behavior. In illustrative examples, jitter or amplitude noise is injected. As will be appreciated, by injecting a controlled and known noise signal into the quantum computing system, qubits can be tested to determine a response to the noise signal. A comparison can be made showing error accumulated from the noise introduced into the system against how much noise is normally seen in a clean signal.

### Example System

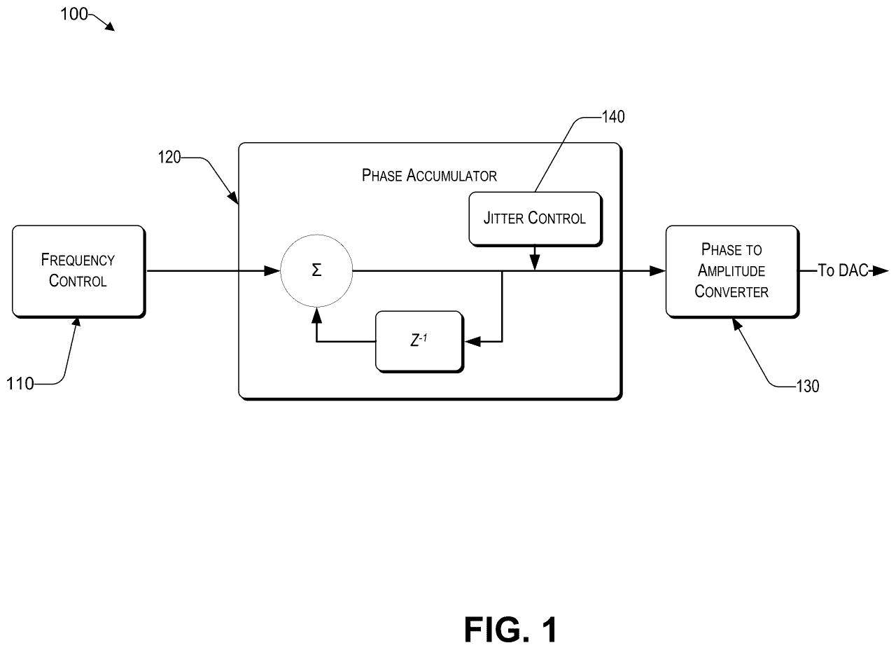

FIG. 1 shows a numerically controlled oscillator 100 (also referred to as the “NCO 100”) according to an illustrative embodiment. The NCO 100 generally includes a phase accumulator 120 and a phase to amplitude converter module 130. The NCO 100 may receive input from a frequency control module 110 and the signal output is sent to a digital to analog converter (DAC). In an illustrative embodiment, the phase accumulator 120 includes a controllable noise source 140. A controlled noise signal is introduced into a signal path of the phase accumulator, which can be provided to an input of the phase to amplitude converter 130. The type of noise and examples of controlled noise input will be described in further detail below.

### NCO Overview

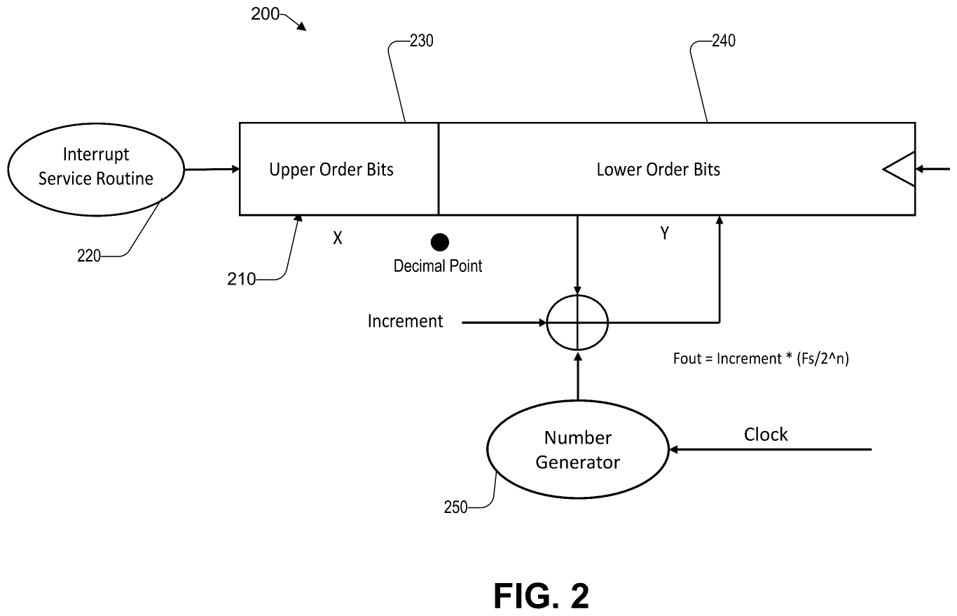

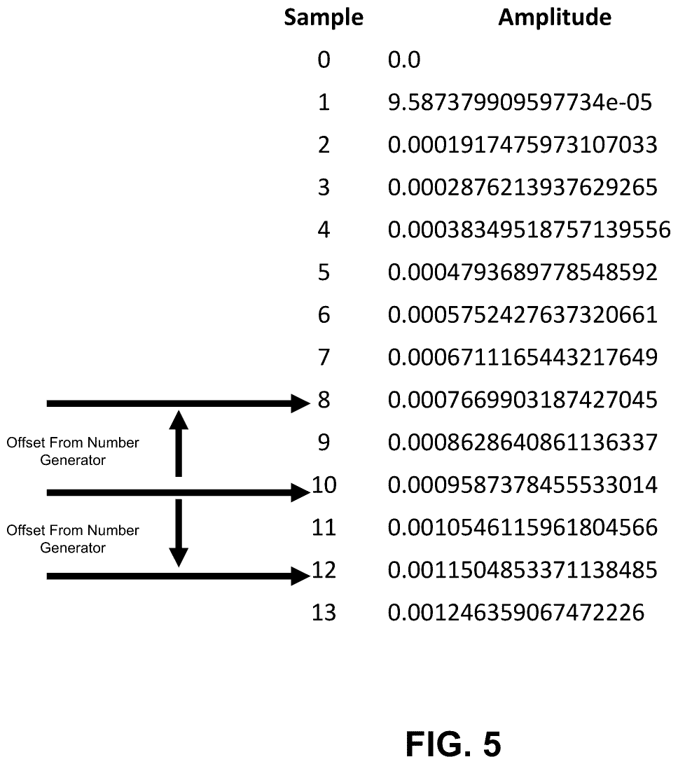

Referring now to FIG. 2, which is a block diagram depicting how one example of an increment process 200 may be performed, consistent with an illustrative embodiment. An interrupt service routine 220 generally triggers software application instructions including the increment process for the NCO. An increment register value 210 includes upper order bits 230 and lower order bits 240. In the example shown, the method uses a look up table, however it will be understood that other methods may be used. In one embodiment using a look up table method, the sine and cosine values of the corresponding phase are calculated according to the phase of the sine and cosine waves, and the phase angle is used as the sine and cosine of the phase. The address is used to construct the phase amplitude conversion circuit. Finally, the sample value of the sine and cosine signal is obtained by looking up these values in a table. The upper order bits 230 for each clock cycle are sent to sine look up table. In the example embodiment of FIG. 2, a number generator module 250 (which may be executable instructions stored in the jitter control module 140 of FIG. 1), may continuously generate numbers dependently/independently from the NCO. The number generator module 250 may be a random number generator in some embodiments. The clock for the number generator module 250 may be a non-integer clock. In some embodiments, the number generator module 250 may use an integer divider clock. The numbers generated may represent the amount of noise added to the system. For example, an amount of jitter may be calculated by the same offsets as the numbers generated. An example of offsets based on the output from the number generator routine is shown in FIG. 5.

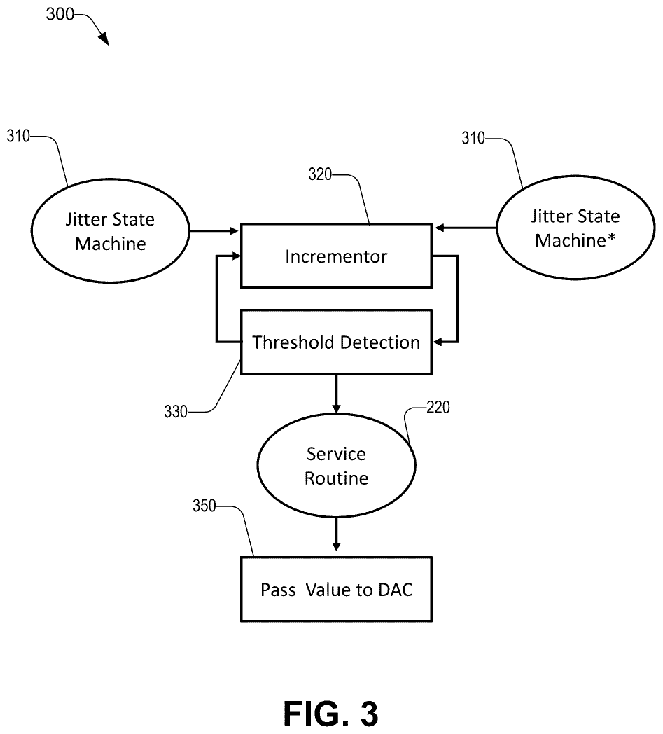

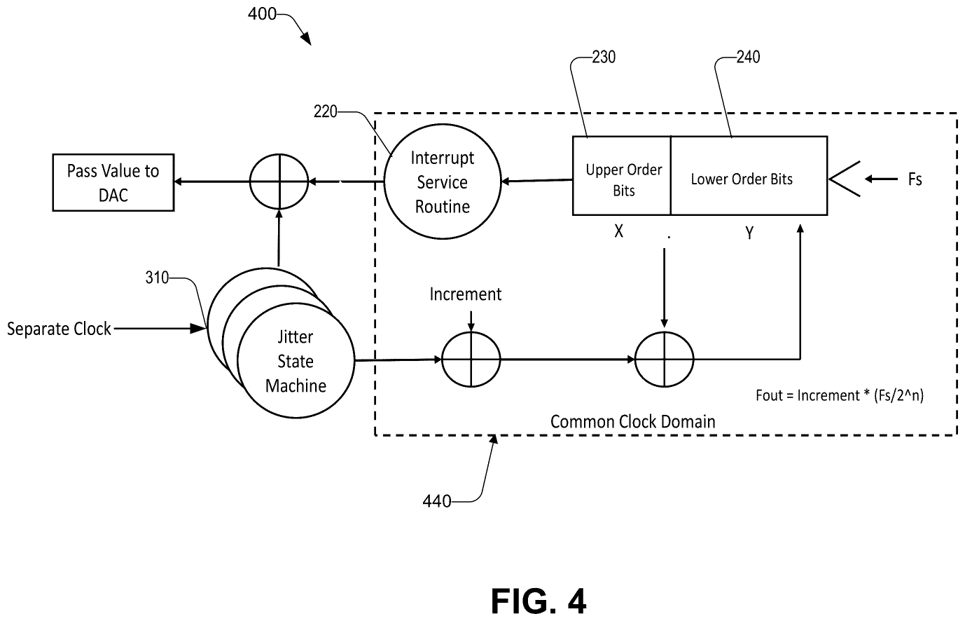

FIGS. 3 and 4 show a process 300 with an accompanying diagrammatic view of an incrementor circuit 400 for injecting controlled noise into a quantum computing system. In an illustrative embodiment, one or more state machines 310 may modify incrementor 320 results with additive effects during a quantum computing operation. The increment may be a value tied to a register or hard-set. The state machines may include for example, random and deterministic types of jitter. Some embodiments may include a threshold detection 330 to ensure that a value exceeding a predetermined maximum would not be passed on to the DAC 350, and/or for counting how many times such an event occurs. A similar situation may hold for minimums. This could prevent one from sending to the DAC voltage values outside the range of the DAC, or from implementing unrealistic phase distortions. The interrupt service routine 220 takes the value it receives (a location in memory or the lookup table) and retrieves the corresponding voltage to be sent to the DAC. Basically, jitter values which affect the location in the lookup table (LUT) can be viewed as injecting phase noise, whereas jitter values affecting the value retrieved from the LUT can be viewed as amplitude noise. The LUT provides the basic waveform. Stepping through the LUT at a fixed increment generates signals with that waveform at a certain frequency. Incrementing the value referring to a location in the LUT generates phase noise; incrementing the value received from the LUT generates amplitude noise. In some embodiments (FIG. 4), the state machines 310 may run on a different clock than the NCO clock domain 440 so that the state machines can do many operations between samples. In one illustrative embodiment (FIG. 4), the final summation is for amplitude noise.

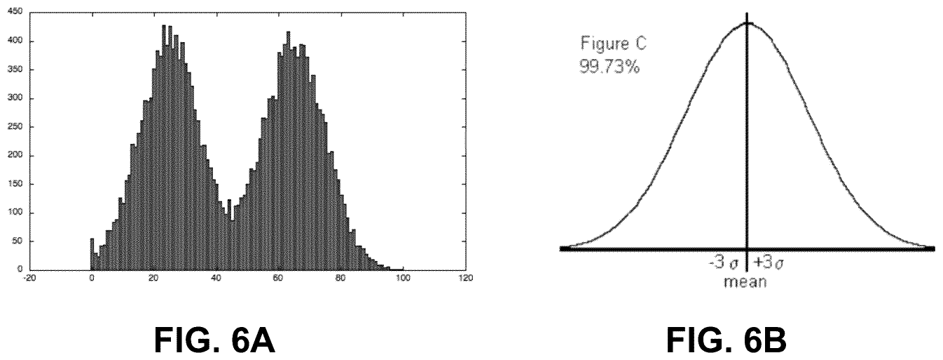

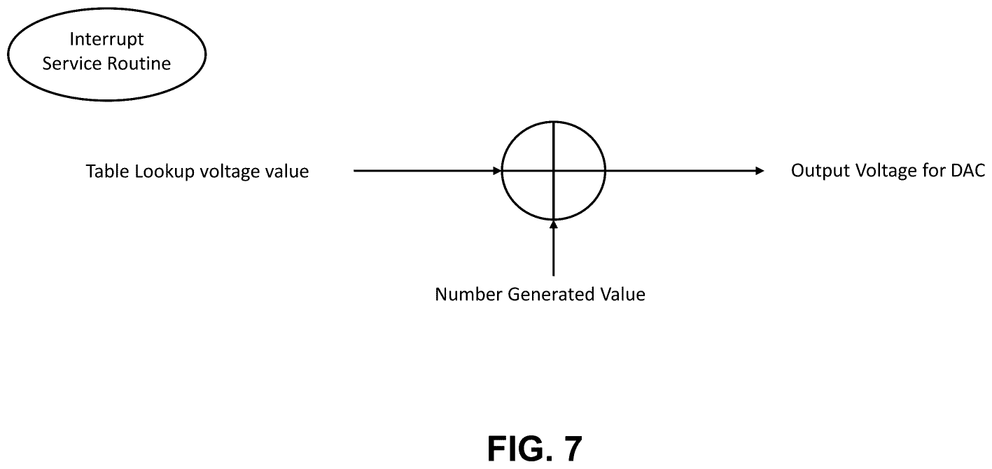

Referring to FIG. 5, a look up table for an NCO generated signal is shown according to an illustrative embodiment. Injecting a controlled noise signal from the embodiment described above may use controlled offsets values provided by the number generator module 250 (FIG. 2). The amount of noise added to the system may be calculated by the same offsets. As may be appreciated, the offset values may be controlled to produce user-controlled distribution models. FIG. 6A shows an example of a bimodal distribution generated by a user controlled offset setting. Weighting may be set towards the extremes of the distribution. FIG. 6B shows an offset setting that generates a Gaussian distribution. In the Gaussian distribution, weighting is set close to a target.

It will be appreciated that aspects of the subject technology provide useful tools and verifiable insights in a quantum computing process. While the noise injected into the system is actually controlled, random jitter may be simulated by incorporating a random number generator on a non-integer clock. Gaussian jitter may be simulated by having a set sequence on an integer divider clock drive the offset values added to the signal. In other embodiments, symmetric and asymmetric bi-modal issues may be simulated by injecting in controlled offsets values. Some embodiments may simulate output amplitude instability by controlling the noise injected into the system.

Referring to FIG. 7, the interrupt service routine may be modified so that the routine takes the value from the incrementation and looks up the sample in the table. The DAC voltage that corresponds to the value is passed to the next stage. Having a state machine that adds to the lookup value can be used to add amplitude instability or impose specific sinusoidal interference to mimic power distribution jitter. Still yet, some embodiments may be modified to provide a compensation circuit for endpoint phase stability.

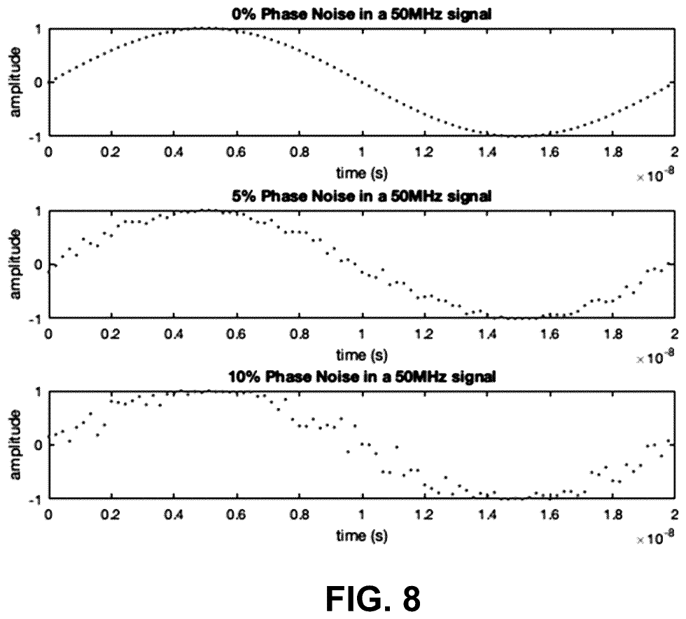

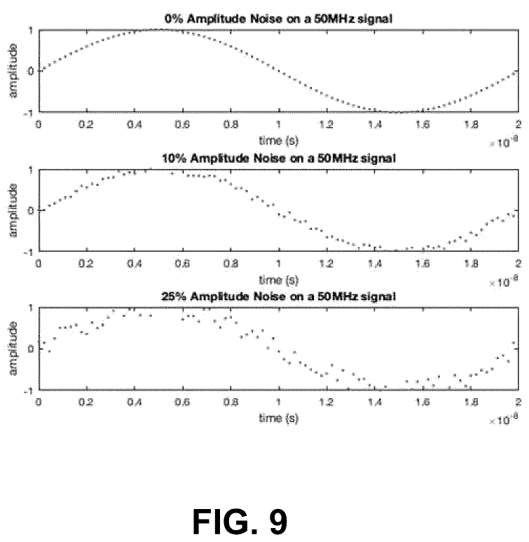

As an illustrative example of the output from the embodiments described above, FIG. 8 shows a resultant phase signal. The top signal shows the baseline signal without any noise injected into the system. The middle signal shows the effect of 5% phase noise controllably injected into the quantum computing system signal. The bottom signal shows the effect of 10% phase noise on the baseline signal. FIG. 9 shows the effects of a controlled amplitude noise on a baseline quantum computing signal output.

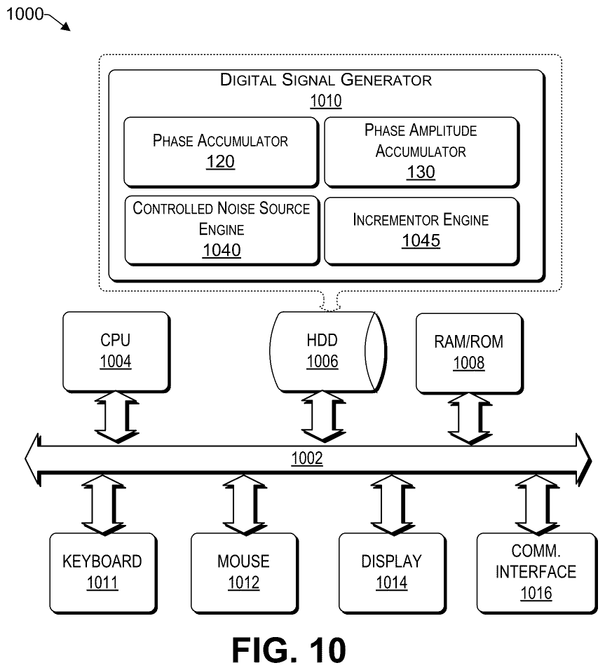

FIG. 10 is a functional block diagram illustration of a computing device 1000 that may provide the machine for generating quantum computing, controlling the injection of controlled noise into a quantum computing system, and/or evaluating the effect of noise on quantum outputs according to embodiments described above. The computer device 1000 may include a central processing unit (CPU) 1004, a hard disk drive (HDD) 1006, random access memory (RAM) and/or read only memory (ROM) 1008, a keyboard 1011, a mouse 1012, a display 1014, and a communication interface 1016, which are connected to a system bus 1002. In one embodiment, the HDD 1006, has capabilities that include storing a program that can execute various processes, such as the control of noise injection into a quantum computing process, in a manner described herein.

In some embodiments, the computing device 1000 may be a standalone computer hardware platform. In some embodiments, the computing device 1000 may be a digital signal generator connected to a general computer platform where each device provides separate capabilities, one for quantum computing and the other device for signal generation. In an illustrative embodiment, the computing device 1000 includes a digital signal generator 1010. The digital signal generator 1010 may be, for example, an NCO. The digital signal generator 1010 may be configured to generate quantum computing signals subjected to controlled noise as described above. Embodiments of the digital signal generator 1010 include the phase accumulator module 120 and the phase amplitude accumulator 130. The digital signal generator 1010 may include a controlled noise source engine 1040 which may be configured for users or automated processes to generate a controlled noise signal that can be used to evaluate the effects of noise on qubits being analyzed. The controlled noise source engine 1040 may include for example, the jitter state machine of FIGS. 3 and 4 to generate controlled noise signals. There may be an incrementor engine 1045 (that uses for example, the incrementor 320 of FIG. 3) that generates the signals under test.

### CONCLUSION

The descriptions of the various embodiments of the present teachings have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

The components, steps, features, objects, benefits and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits and advantages. These also include embodiments in which the components and/or steps are arranged and/or ordered differently.

Aspects of the present disclosure are described herein with reference to call flow illustrations and/or block diagrams of a method, apparatus (systems), and computer program products according to embodiments of the present disclosure. It will be understood that each step of the flowchart illustrations and/or block diagrams, and combinations of blocks in the call flow illustrations and/or block diagrams, can be implemented by computer readable program instructions.

These computer readable program instructions may be provided to a processor of a computer, special purpose computer, or other programmable data processing apparatus to produce a machine, such that the instructions, which execute via the processor of the computer or other programmable data processing apparatus, create means for implementing the functions/acts specified in the call flow process and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the call flow and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the call flow process and/or block diagram block or blocks.

The flowchart and block diagrams in the Figures illustrate the architecture, functionality, and operation of possible implementations of systems, methods, and computer program products according to various embodiments of the present disclosure. In this regard, each block in the call flow process or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or call flow illustration, and combinations of blocks in the block diagrams and/or call flow illustration, can be implemented by special purpose hardware-based systems that perform the specified functions or acts or carry out combinations of special purpose hardware and computer instructions.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments have more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A method of controlling a quantum computing output, comprising:
generating a baseline quantum computing signal from a quantum computing system;
adding a controlled noise component to the quantum computing system;
reading an output from the quantum computing system, wherein the output includes the controlled noise component; and
determining an effect on the baseline quantum computing signal due to the controlled noise component in the output.

2. The method of claim 1, wherein the controlled noise component is jitter.

3. The method of claim 1, wherein the controlled noise component is amplitude noise.

4. The method of claim 1, further comprising producing the controlled noise component from a number generator.

5. The method of claim 1, wherein the controlled noise component is an offset value added to a value obtained from a look up table.

6. A computer program product for controlling a quantum computing output, the computer program product comprising:
one or more computer readable storage media, and program instructions collectively stored on the one or more computer readable storage media, the program instructions comprising:
generating a baseline quantum computing signal from a quantum computing system;
adding a controlled noise component to the quantum computing system;
reading an output from the quantum computing system, wherein the output includes the controlled noise component; and
determining an effect on the baseline quantum computing signal due to the controlled noise component in the output.

7. The computer program product of claim 6, wherein the controlled noise component is jitter.

8. The computer program product of claim 6, wherein the controlled noise component is amplitude noise.

9. The computer program product of claim 6, wherein the program instructions further comprise producing the controlled noise component from a number generator.

10. The computer program product of claim 6, wherein the controlled noise component is an offset value added to a value obtained from a look up table.

11. A controller module for controlling a quantum computing output in a quantum computing system, comprising:
a computer processor;
a controlled noise source generator; and
one or more computer readable storage media, and program instructions collectively stored on the one or more computer readable storage media, the program instructions comprising, when executed by the computer processor:
generating a baseline quantum computing signal from a quantum computing system,
adding a controlled noise component, generated by the controlled noise source generator, to the quantum computing system,
reading an output from the quantum computing system, wherein the output includes the controlled noise component, and
determining an effect on the baseline quantum computing signal due to the controlled noise component in the output.

12. The controller module of claim 11, wherein the controlled noise component is jitter.

13. The controller module of claim 11, wherein the controlled noise component amplitude noise.

14. The controller module of claim 11, wherein the program instructions further comprise producing the controlled noise component from a number generator.

15. The controller module of claim 11, wherein the controlled noise component is an offset value added to a value obtained from a look up table.

16. A quantum computing system, comprising:
a computing device, including a computer processor;
a digital signal generator coupled to the computing device; and
a controlled noise source module coupled to the digital signal generator, wherein the computer processor is configured to:
generate a baseline quantum computing signal from the digital signal generator;
generate a controlled noise signal from the controlled noise source module;
inject the controlled noise signal to the baseline quantum computing signal; and
generate a modified quantum computing signal showing an effect on a qubit behavior due to the controlled noise signal.

17. The quantum computing system of claim 16, wherein the controlled noise signal is jitter.

18. The quantum computing system of claim 16, wherein the controlled noise signal is amplitude noise.

19. The quantum computing system of claim 16, wherein the computer processor is further configured to produce the controlled noise signal from a number generator.

20. The quantum computing system of claim 16, wherein the controlled noise signal is an offset value added to a value obtained from a look up table.

21. A numerically controlled oscillator, comprising:
a phase accumulator module, wherein the phase accumulator is configured to generate a baseline output signal representing a baseline qubit behavior in a quantum computation;
a phase to amplitude converter module coupled to the phase accumulator module; and
a noise source controller coupled to the phase accumulator module, wherein:
a controlled noise signal is injected into the baseline output signal of the phase accumulator;
a modified output signal is generated in response to the injection of the controlled noise signal; and
the modified output signal represents an effect on the baseline qubit behavior due to a magnitude of the controlled noise signal.

22. The numerically controlled oscillator of claim 21, wherein the controlled noise signal is jitter.

23. The numerically controlled oscillator of claim 21, wherein the controlled noise signal is amplitude noise.

24. The numerically controlled oscillator of claim 21, wherein the controlled noise signal is provided by a number generator.

25. The numerically controlled oscillator of claim 21, wherein the controlled noise signal is an offset value added to a value obtained from a look up table.
